(19) United States
(12) Patent Application Publication
(10) Pub. No.: US 2010/0179895 A1
(43) Pub. Date: Jul. 15, 2010

(54) DIGITAL CONTENT DELIVERY SYSTEMS AND METHODS AND RELATED MACHINES

(75) Inventors: Chi-Yang Chou, Kao-hsiung (TW); Pei-Yen Chou, Hsin-chu (TW); Yeu-Chung Lin, Chang-hua (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CONDEL INTERNATIONAL TECHNOLOGIES INC., George Town (KY)

(21) Appl. No.: 12/352,649

(22) Filed: Jan. 13, 2009

(51) Int. Cl. H04L 9/32; G06Q 10/00; G06Q 30/00; G06Q 50/00; G06Q 20/00; G06F 17/00

(52) U.S. Cl. 705/34; 705/30; 705/40; 726/30; 726/28

(57) ABSTRACT

Digital content delivery system and method are provided. The system includes a central management system and a delivery machine coupled to the central management system via a network. The delivery machine includes a storage unit including a plurality of DRM (Digital Rights Management) contents, a user interface, and a connection interface. The delivery machine receives a selection of at least one of the DRM contents via the user interface, and transmits order information corresponding to the selection of the selected DRM content to the central management system via the network. The central management system generates a rights object for the selected DRM content according to the order information, and transmits the rights object to the delivery machine. The delivery machine transmits the selected DRM content and the rights object to a storage device via the connection interface.

### BACKGROUND OF THE INVENTION

1. Field of the Invention

The disclosure relates generally to digital content delivery systems and methods, and, more particularly to systems and methods that locally deliver DRM (Digital Rights Management) contents and remotely download rights objects to storage devices, and related machines.

2. Description of the Related Art

With electronic devices, such as computers or portable devices, being popular, digital content has become a major data recording type for the devices due to increased convenience of digital content. Moreover, content providers have been devoted to develop more related applications for digital content.

Currently, two conventional delivery manners can be used for digital content. In an off-line manner, digital content is stored in a disc, such as a CD/VCD/DVD. Users can obtain the digital content from marketing systems, such as music/movie stores, and play back the digital content at any time, and in any playback device. Since content has been recorded in the discs, it is efficient for users to obtain and play back the digital content. However, since content, such as music titles on the discs is fixed, it is inflexible for users. Additionally, since management of marketing systems is difficult and related operating costs high, the digital content business model for the off-line manner has reached a bottleneck.

In an on-line manner, DRM content and/or a rights object can be downloaded via an internet or a mobile phone system to a memory of a playback device. Once the DRM content and the rights object are delivered to the playback device, the DRM engine on the playback device combines the DRM content and the rights object to generate a content file, and bundles the content file with a device code of the playback device. When an electronic appliance wants to access the content, it is determined whether or not the device code of the electronic appliance matches the device code bundled with the content file. If the device code of the electronic appliance matches the device code bundled with the content file, the electronic appliance accesses the content. In this manner, the content is forced to be bundled to a specific device, thus seriously limiting a user's fair use right of owning the content, since a user will not be able to access the content with other devices. Additionally, since the size of content, such as movies may be large, content downloading is time-consuming due to limited network bandwidth.

### BRIEF SUMMARY OF THE INVENTION

Digital content delivery systems and methods and related machines are provided.

An embodiment of a digital content delivery system includes a central management system and a delivery machine coupled to the central management system via a network. The delivery machine includes a storage unit including a plurality of DRM (Digital Rights Management) contents, a user interface, and a connection interface. The delivery machine receives a selection of at least one of the DRM contents via the user interface, and transmits order information corresponding to the selection of the selected DRM content to the central management system via the network. The central management system generates a rights object for the selected DRM content according to the order information, and transmits the rights object to the delivery machine. The delivery machine transmits the selected DRM content and the rights object to a storage device via the connection interface.

An embodiment of a delivery machine includes a storage unit including a plurality of DRM (Digital Rights Management) contents, a user interface, and a connection interface. The delivery machine receives a selection of at least one of the DRM contents via the user interface, and transmits order information corresponding to the selection of the selected DRM content to a central management system via a network. The delivery machine receives a rights object generated according to the order information for the selected DRM content from the central management system, and transmits the selected DRM content and the rights object to a storage device via the connection interface.

In an embodiment of a digital content delivery method, a selection of at least one of DRM contents in a delivery machine is received via a user interface. Order information corresponding to the selection of the selected DRM content is transmitted to a central management system via a network. Then, a rights object generated according to the order information for the selected DRM content is received from the central management system. The selected DRM content and the rights object is transmitted to a storage device via a connection interface.

In some embodiments, the delivery machine can read a UID of the storage device via the connection interface, receive a password via the user interface, and transmit the UID and the password to the central management system. The central management system can authenticate the storage device according to the UID and the password.

Digital content delivery methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a digital content delivery system according to the invention;

FIG. 2 is a schematic diagram illustrating an embodiment of a central management system according to the invention;

FIG. 3 is a schematic diagram illustrating an embodiment of a delivery machine according to the invention;

FIG. 4 is a flowchart of an embodiment of a digital content delivery method according to the invention; and

FIG. 5 is a flowchart of another embodiment of a digital content delivery method according to the invention.

### DETAILED DESCRIPTION OF THE INVENTION

Digital content delivery systems and methods and related machines are provided.

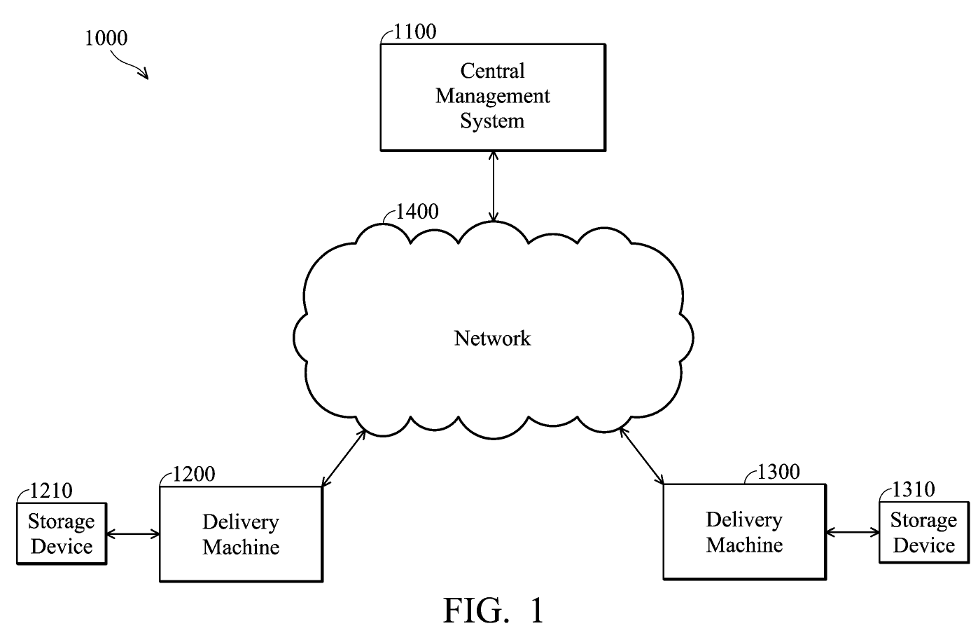

FIG. 1 is a schematic diagram illustrating an embodiment of a digital content delivery system according to the invention.

The digital content delivery system 1000 comprises a central management system 1100, and at least one delivery machine (1200 and 1300). Each delivery machine is connected to the central management system 1100 via a network 1400, such as an Internet, a wireless network, and a telecommunication network. Each delivery machine may be coupled with a storage device, for example, the delivery machine 1200 is coupled with a storage device 1210, and the delivery machine 1300 is coupled with a storage device 13 10. The storage device may be a flash memory device, such as an SD (Secure Digital) card. In some embodiments, the storage device may have a UID. It is understood that, in some embodiments, the storage device may comprise a semiconductor component, such as a memory or a micro-processor. The UID is a hardware serial number generated for the semiconductor component during manufacturing or a virtual serial number created for the semiconductor component by firmware/software. Additionally, the storage device may have a public area and a hidden area. A DRM content can be delivered to the public area of storage device, and a rights object can be delivered to the hidden area of the storage device. Related detail is discussed later. Further, in some embodiments, the DRM content may be encrypted using an encryption/decryption algorithm, such as symmetric or asymmetric encryption/decryption algorithms. In the embodiments, the hidden area of the storage device may further comprise at least a key (not shown) used to decrypt the DRM content according to the encryption/decryption algorithm.

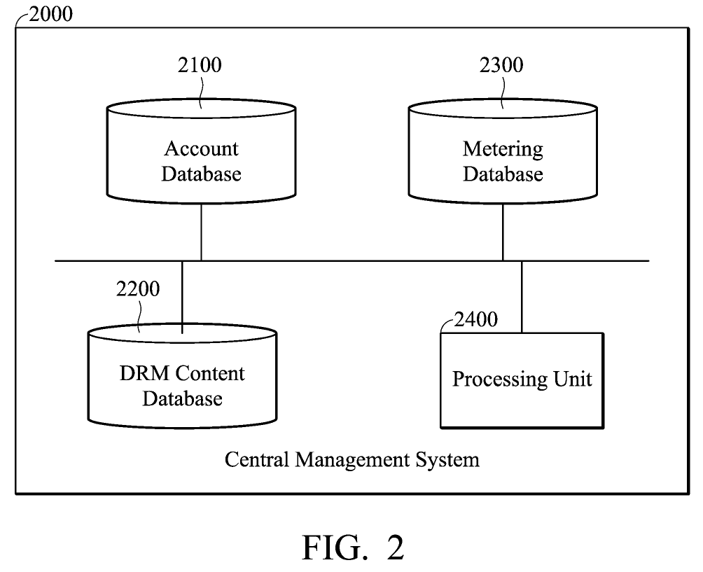

FIG. 2 is a schematic diagram illustrating an embodiment of a central management system according to the invention.

The central management system 2000 comprises an account database 2100, a DRM content database 2200, a metering database 2300, and a processing unit 2400. The account database 2100 can record account information for users. The account information may comprise a user ID, at least one UID of a storage device, a password, and/or a corresponding prepaid credit. It is noted that each user can purchase the prepaid credit in advance, and when a user select DRM content for delivery, the user's prepaid credit is deducted according to the selected DRM content. The use of the account database 2100 is discussed later. The DRM content database 2200 comprises a plurality of DRM contents. Each of the DRM content may be a content, wherein DRM is performed. It is understood that, the DRM can vary according to different requirements and applications. Similarly, in some embodiments, the DRM content may be encrypted using an encryption/decryption algorithm, such as symmetric or asymmetric encryption/decryption algorithms. The metering database 2300 can record the delivery situation, such as times and corresponding means for authorization for each DRM content. It is understood that, the central management system 2000 may also comprise a communication interface to connect with the network 1400. The processing unit 2400 performs the digital content delivery method on the central management system 2000. Related detail is discussed later.

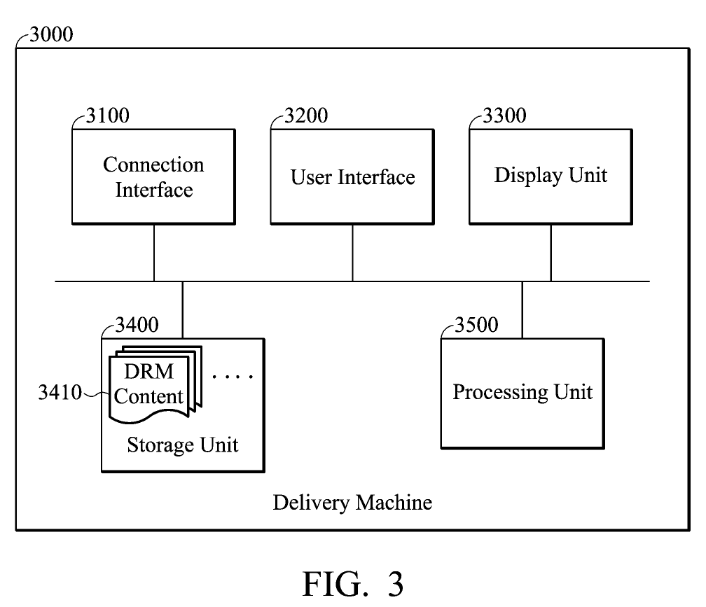

FIG. 3 is a schematic diagram illustrating an embodiment of a delivery machine according to the invention.

The delivery machine 3000 comprises a connection interface 3100, a user interface 3200, a display unit 3300, a storage unit 3400, and a processing unit 3500. The connection interface 3100 may be a card reader or a USB slot used to couple with the storage device. The user interface 3200 can be used to retrieve, browse, and select at least one of the DRM contents in the delivery machine 3000. The display unit 3300 can display the user interface 3200, and preview of the selected DRM content. It is understood that, in some embodiments, the display unit 3300 may be a touch-sensitive screen, and users can directly use the touch-sensitive screen and the user interface to input related data. The storage unit 3400 comprises a plurality of DRM contents 3410. It is understood that, in some embodiments, the DRM contents 3410 can be received from the central management system 2000 via the network 1400. In some embodiments, the DRM contents in the DRM content database 2200 of the central management system 2000 can be first stored in a portable memory device, and then brought to the delivery machine 3000. Then, the portable memory device can be coupled to the delivery machine 3000 via the connection interface 3100, wherein the DRM contents are copied to the storage unit 3400 of the delivery machine 3000. It is noted that, in some embodiments, a protection mechanism is applied to the storage unit 3400. In the protection mechanism, an administrator password and/or a predefined procedure must be performed for disassembly of the storage unit 3400. When no administrator password is provided or the predefined procedure is not followed, the storage unit 3400 is automatically formatted to delete the DRM contents therein. The processing unit 3500 performs the digital content delivery method on the delivery machine 3000. Related detail is discussed later.

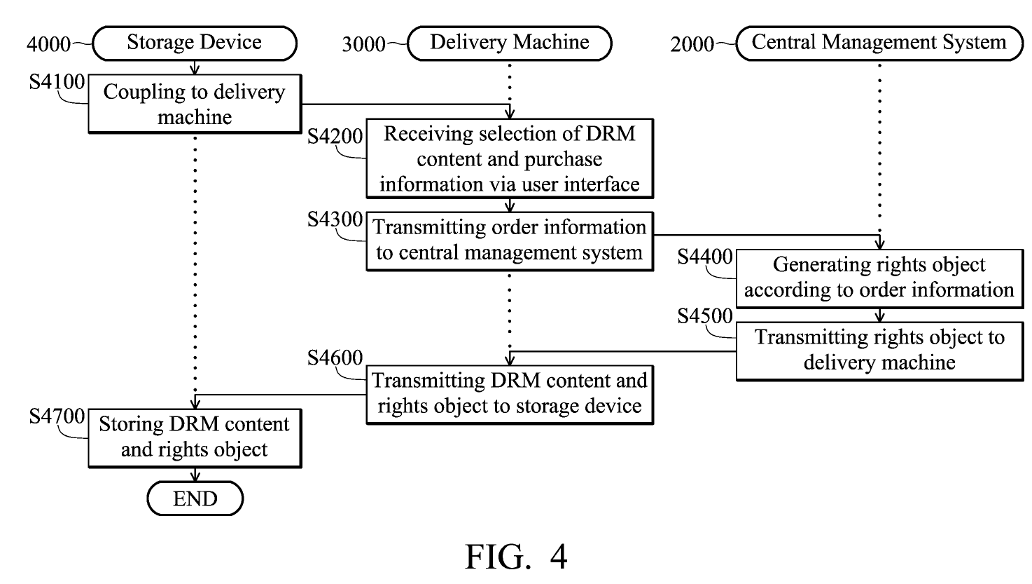

FIG. 4 is a flowchart of an embodiment of a digital content delivery method according to the invention.

In step S4100, a storage device 4000 couples to the delivery machine 3000 via the connection interface 3100. As described, users can use the user interface 3200 to retrieve, browse, and select at least one of the DRM contents 3410 in the delivery machine 3000. In step S4200, the delivery machine 1200 receives a selection of at least one of the DRM contents 3410, and corresponding purchase information comprising a means for authorization for the selected DRM content via the user interface 3200. In step S4300, the delivery machine 1200 generates and transmits order information comprising the purchase information, corresponding to the selection of the selected DRM content, to the central management system 2000 via the network 1400. After the central management system 2000 receives the order information from the delivery machine 3000, in step S4400, the central management system 2000 generates a rights object for the selected DRM content according to the order information, and in step S4500 transmits the rights object to the delivery machine 3000. It is understood that, the central management system 2000 may update the metering database 2300 according to the order information. After the delivery machine 3000 receives the rights object, in step S4600, the delivery machine 3000 transmits the selected DRM content and the received rights object to the storage device 4000. In step S4700, the storage device 4000 stores the selected DRM content and rights object. In some embodiments, the selected DRM content is stored in the public area of the storage device 4000, and the rights object is stored in the hidden area of the storage device 4000. In some embodiments, a playback module in the storage device 4000 or an electronic device may have a DRM engine performing DRM to the selected DRM content in the storage device 4000 based on the rights object, and accordingly play back the selected DRM content.

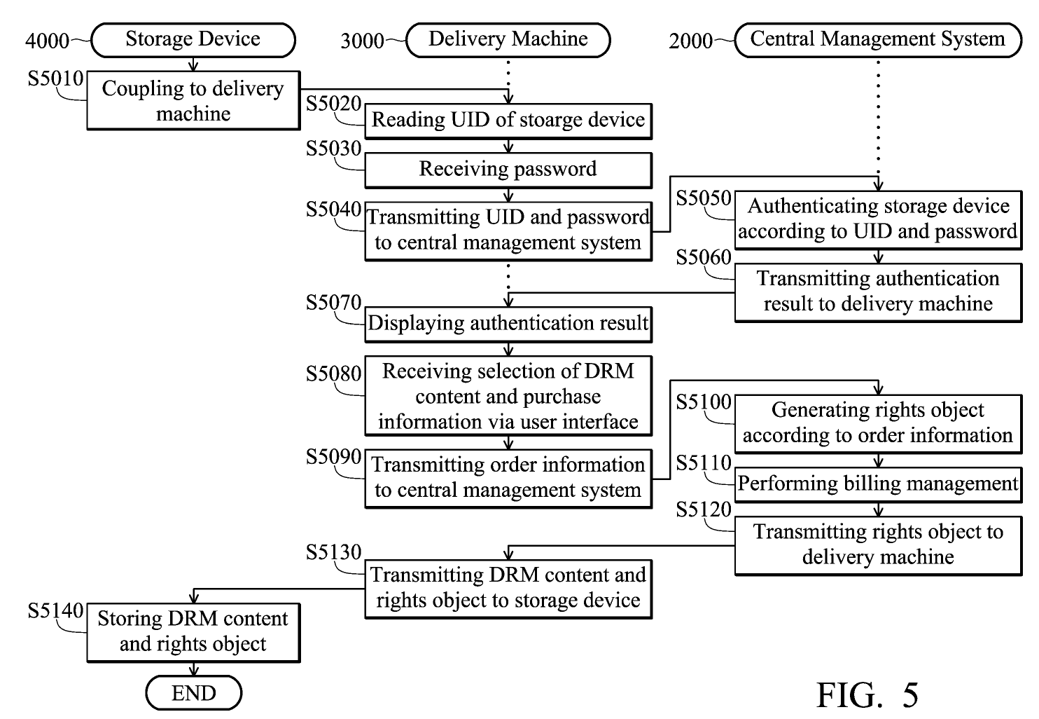

FIG. 5 is a flowchart of another embodiment of a digital content delivery method according to the invention. In this embodiment, authentication for storage devices, and related billing procedures are further discussed.

In step S5010, a storage device 4000 couples to the delivery machine 3000 via the connection interface 3100. In step S5020, the delivery machine 1200 reads a UID of the storage device 4000 via the connection interface 3 100. Similarly, the storage device 4000 may comprise a semiconductor component, such as a memory or a micro-processor of the storage device. The UID may be a hardware serial number generated for the semiconductor component during manufacturing or a virtual serial number created for the semiconductor component by firmware/software. In step S5030, the delivery machine 3000 receives a password. It is understood that, the delivery machine 3000 can display a message to prompt users to input the password. In step S5040, the delivery machine 3000 transmits the UID of the storage device 4000 and the password to the central management system 2000. After the central management system 2000 receives the UID of the storage device 4000 and the password, in step S5050, the central management system 2000 performs authentication for the storage device 4000. In some embodiments, the central management system 2000 determines whether the received password matches the password corresponding to the received UID in the account database 2100. In step S5060, the central management system 2000 transmits the authentication result to the delivery machine 3000. It is understood that, in some embodiments, the authentication result may be an error message if the received password does not match the password corresponding to the received UID in the account database 2100. In some embodiments, the authentication result may comprise the remnant prepaid credit corresponding to the storage device 4000 if the received password matches the password corresponding to the received UID in the account database 2100. After the delivery machine 3000 receives the authentication result, in step S5070, the delivery machine 3000 displays the authentication result.

Similarly, users can use the user interface 3200 to retrieve, browse, and select at least one of the DRM contents 3410 in the delivery machine 3000. In step S5080, the delivery machine 1200 receives a selection of at least one of the DRM contents 3410, and corresponding purchase information comprising a means for authorization for the selected DRM content via the user interface 3200. In step S5090, the delivery machine 1200 generates and transmits order information comprising the purchase information, corresponding to the selection of the selected DRM content, to the central management system 2000 via the network 1400. After the central management system 2000 receives the order information from the delivery machine 3000, in step S5100, the central management system 2000 generates a rights object for the selected DRM content according to the order information. In step S5110, the central management system 2000 performs billing management according to the order information. In some embodiments, the central management system 2000 can generate billing information regarding the order information, and deduct the billing information from the prepaid credit corresponding to the storage device recorded in the corresponding account information. It is noted that, a preset credit may be predefined for each DRM content as a specific authorization means. The corresponding preset credit can be located according to the order information, and deducted from the prepaid credit corresponding to the storage device recorded in the corresponding account information. In some embodiments, the central management system 2000 can generate the billing information regarding the order information, and transmit the billing information to the delivery machine 3000 via the network 1400. The delivery machine 3000 can display the billing information, and receive a payment corresponding to the billing information. That is, the payment is performed on the delivery machine 3000. In some embodiments, the payment is carried out by receiving a credit card or cash via a payment reception unit (not shown) of the delivery machine 3000. It is noted that, the billing management of the present invention is not limited thereto. In step S5120, the central management system 2000 transmits the rights object to the delivery machine 3000. Similarly, the central management system 2000 may update the metering database 2300 according to the order information. After the delivery machine 3000 receives the rights object, in step S5130, the delivery machine 3000 transmits the selected DRM content and the received rights object to the storage device 4000. In step S5140, the storage device 4000 stores the selected DRM content and rights object. Similarly, the selected DRM content is stored in the public area of the storage device 4000, and the rights object is stored in the hidden area of the storage device 4000. In some embodiments, a playback module in the storage device 4000 or an electronic device may have a DRM engine performing DRM to the selected DRM content in the storage device 4000 based on the rights object, and accordingly play back the selected DRM content.

Therefore, the digital content delivery systems and methods and related machines can locally deliver DRM contents to storage devices, and remotely download rights objects to storage devices, thus improving delivery efficiency and maintaining the security of DRM contents.

Digital content delivery methods, or certain aspects or portions thereof, may take the form of a program code (i.e., executable instructions) embodied in tangible media, such as flash card or USB disk, wherein, when the program code is loaded into and executed by a machine, such as a computer, the machine thereby becomes an apparatus for practicing the methods.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A digital content delivery system, comprising:
a central management system; and
a delivery machine coupled to the central management system via a network,
comprising:
a storage unit comprising a plurality of DRM (Digital Rights Management) contents;
a user interface; and
a connection interface,
wherein the delivery machine receives a selection of at least one of the DRM contents via the user interface, and transmits order information corresponding to the selection of the selected DRM content to the central management system via the network,
wherein the central management system generates a rights object for the selected DRM content according to the order information, and transmits the rights object to the delivery machine, and the delivery machine transmits the selected DRM content and the rights object to a storage device via the connection interface.

2. The system of claim 1, wherein the delivery machine further reads a UID of the storage device via the connection interface, receives a password via the user interface, and transmits the UID and the password to the central management system, wherein the central management system authenticates the storage device according to the UID and the password.

3. The system of claim 1, wherein the central management system further performs DRM to a plurality of contents to obtain the DRM contents, wherein the DRM contents are transmitted from the central management system to the delivery machine via the network, or the DRM contents are stored in a portable memory device, and then copied to the delivery machine via the connection interface.

4. The system of claim 1, wherein the delivery machine further receives purchase information via the user interface, wherein the purchase information comprises a means for authorization for the selected DRM content, and the order information comprises the purchase information.

5. The system of claim 4, wherein the central management system further generates billing information regarding the order information, and deducts the billing information from prepaid credit corresponding to the storage device.

6. The system of claim 4, wherein the central management system further generates billing information regarding the order information, transmits the billing information to the delivery machine via the network, and the delivery machine receives a payment corresponding to the billing information, wherein the payment is carried out by receiving a credit card or cash via a payment reception unit of the delivery machine.

7. A delivery machine, comprising:
a storage unit comprising a plurality of DRM (Digital Rights Management) contents;
a user interface; and
a connection interface,
wherein the delivery machine receives a selection of at least one of the DRM contents via the user interface, transmits order information corresponding to the selection of the selected DRM content to a central management system via a network, receives a rights object generated according to the order information for the selected DRM content from the central management system, and transmits the selected DRM content and the rights object to a storage device via the connection interface.

8. The system of claim 7, wherein the delivery machine further reads a UID of the storage device via the connection interface, receives a password via the user interface, and transmits the UID and the password to the central management system for authentication.

9. The system of claim 7, wherein the delivery machine further receives purchase information via the user interface, wherein the purchase information comprises a means for authorization for the selected DRM content, and the order information comprises the purchase information.

10. The system of claim 9, wherein the delivery machine further receives billing information regarding the order information from the central management system, and receives a payment corresponding to the billing information, wherein the payment is carried out by receiving a credit card or cash via a payment reception unit of the delivery machine.

11. A digital content delivery method for use in a delivery machine, comprising:
receiving a selection of at least one of DRM contents in the delivery machine via a user interface;
transmitting order information corresponding to the selection of the selected DRM content to a central management system via a network;
receiving a rights object generated according to the order information for the selected DRM content from the central management system; and
transmitting the selected DRM content and the rights object to a storage device via a connection interface.

12. The method of claim 11, further comprising:
reading a UID of the storage device via the connection interface;
receiving a password via the user interface; and
transmitting the UID and the password to the central management system,
wherein the central management system authenticates the storage device according to the UID and the password.

13. The method of claim 11, wherein the central management system further performs DRM to a plurality of contents to obtain the DRM contents, and the DRM contents are transmitted from the central management system to the delivery machine via the network, or the DRM contents are stored in a portable memory device, and then copied to the delivery machine via the connection interface.

14. The method of claim 11, further comprising receiving purchase information via the user interface, wherein the purchase information comprises a means for authorization for the selected DRM content, and the order information comprises the purchase information.

15. The method of claim 14, wherein the central management system further generates billing information regarding the order information, and deducts the billing information from prepaid credit corresponding to the storage device.

16. The method of claim 14, further comprising:
receiving billing information regarding the order information from the central management system via the network; and
receiving a payment corresponding to the billing information,
wherein the payment is carried out by receiving a credit card or cash via a payment reception unit of the delivery machine.
